(19) United States
(12) Patent Application Publication
(10) Pub. No.: US 2005/0209907 A1
(43) Pub. Date: Sep. 22, 2005

(54) 3-D customer demand rating method and apparatus

(76) Inventor: Gary Alan Williams, San Diego, CA (US)

Correspondence Address: GARY A. WILLIAMS, 7233 NW 116 th Way, Parkland, FL, 33076, US

(21) Appl. No.: 10/802,108

(22) Filed: Mar. 17, 2004

(51) Int. Cl. G06F 17/60

(52) U.S. Cl. 705/10

(57) ABSTRACT

A method and apparatus for quantifying and rating customer demand based on measuring desires, delivery and dollars paid. The 3-D customer demand rating method and apparatus provides a series of steps for building, collecting, indexing, rating and analyzing the demand levels customers have for a particular supplier. Customers submit their desires for a set of attributes and evaluate a supplier's ability to delivery them for a given price. Indexed scores for desires, delivery and dollars paid with common scales provide direct comparison and interpretation of which attributes suppliers deliver on best. Demand ratings for each supplier provide a way to benchmark competitors. Groups of customers that possess similar levels of desire and are willing to pay the same price are created. These demand segments are then used so suppliers can create the right mix of Attributes to offer at the right price.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### FIELD OF THE INVENTION

This invention relates to a rating method and apparatus that quantifies customer demand based on desires, delivery and dollars. More specifically, the method combines ratings of customers' desires, suppliers' abilities to deliver on those desires, and the dollars paid for that delivery to quantify the level of demand for a supplier and its offerings. The ratings further quantify the level of untapped demand existing within a defined market.

### BACKGROUND OF THE INVENTION

Companies that deliver better on customers' desires at a fair price than their competitors win more business. While simple to understand, the ability to accomplish this daunting task on a consistent basis remains elusive for most today.

The basic approach for companies is to focus on supply-side economics to build products and services, then attempt to stimulate demand by advertising, publicity, marketing and distribution means. Many companies include some customer input via market research, but their basic approach remains the same in trying to find demand for an offering that is already available for delivery. If little demand is found in comparison to competitors, companies then rely on the last option available to them to spur demand, which is to lower price.

Most companies think of demand in terms of what they can deliver in return for a specific price point in time. The delivery is based upon tangible measures that are easiest to understand and most conveniently available. For example, airlines often adjust their pricing based on how full a given aircraft is and when a ticket is purchased, leaving those travelers at the last minute paying the highest price per seat. Should the traveler in the seat next to them pay a fraction of the cost for a ticket? According to yield management and strong supply-side economics, the answer is yes since either supply or time was at a premium for the customer. Yet, is this fair pricing to the customer? The answer is that it might be for some customers, and might not be for others. The missing part to determining fair pricing is how much desire the traveler has to fly to that destination on that particular day/time and on that particular airline.

The vast majority of demand models focus on using historical and event data, giving little to no attention to true customers' desires for the offering. The concept of desire—which includes both tangible and intangible factors—is what completes the demand equation. Rather than a two-dimensional approach to demand that only covers supply/delivery and price, three dimensions interact to fully calculate demand: delivery, dollars and desire.

Three key challenges exist for suppliers today in assessing demand for their offerings and setting price points in relation to deliverables and desires.

The first challenge is in how companies conduct their measurements. Whether suppliers recognize it or not, customers have a pre-determined set of desires for Attributes—the features, functions, benefits, actions and programs that a supplier delivers—in a particular product, service or offering. Suppliers often collect data about Attributes by tracking customer needs (desires), their internal operations (delivery) and their pricing (dollars)—yet most is collected in separate areas at varying points in time, from different customers or prospective customers and using separate techniques. This makes direct comparisons of data across the dimensions virtually impossible to perform with any level of accuracy or confidence. No single method integrates the measurement of customer desires for Attributes, ability of a supplier to deliver on those Attributes, ability of competitors to deliver on those Attributes, the prices paid for those Attributes, and the customers' willingness to pay for the Attributes desired most. This means that suppliers must try to adjust for multiple data fields collected over varying points in time from different respondents. This would require enormous attention to detail, if possible at all. As a consequence, suppliers miss opportunities to gain market share and increase profits by delaying or, worse yet, never making decisions on how to adjust Attributes and their pricing.

The second challenge is that most analysis done on data collected assumes that growth and change occurs in a linear fashion. Suppliers arrive at and use research directly from their original, linear-based scales, yet business virtually always moves in a curvilinear or S-curve pattern. The S-curve pattern has been made famous through numerous publications, and is often referred to as a paradigm shift, an inflection point or the tipping point. The concept is simple to understand. In any mass market or large respondent study, the mass of responses tends to aggregate around certain points in a mid-range leaving tails at both the top and bottom ends. For example, the performance of an airline on a scale of 1 to 10 may yield an average of 7.84. Yet, plotting the raw responses in terms of percentiles shows that the 10% mark of respondents may occur at 2.93 and the 90% mark of respondents at 9.16. Whereas the upper-end performance of 9.16 is only 1.32 points away from the average, the difference from the average is just as critical as the low-end rating of 2.93 that is 4.91 points away. Most suppliers fail to see the criticality of this enormous difference and fail to interpret the results accordingly. They operate using only linear calculations and thus never see the true difference between ratings.

The third challenge is that most companies rely on one of three types of customer or market research models: 1) A mass-market approach where one size fits all, 2) A demographic-based approach that identifies a target group of customers based on age, income, geography, lifestyle, or occupation, and then applies the one size fits all approach, or 3) A one-to-one approach that requires implementing virtually unlimited combinations of Attributes. In the former two models, suppliers are leaving revenues and profits on the table by deploying singularly focused offerings that meet only a subset of the customers' needs. The latter model requires a substantial investment in resources to both create and deliver with consistency, typically at such unprofitable levels.

The 3-D customer demand rating method and apparatus in this invention overcomes these challenges.

### DESCRIPTION OF THE PRIOR ART

In reviewing the prior art, the three main categories include business strategy, customer or market research and pricing models.

Companies today must continually develop new, or modify existing, business strategies to survive. These strategies typically cover a highly integrated set of internal supplier resources and programs across diverse functions such as marketing, communications, advertising, sales, billing, research and development, products, services, implementation and support. To prevent obsolescence, companies must also simultaneously track the strategies of competitors across that same set of functions. Due to the highly competitive nature and difficulty of obtaining this data, suppliers often rely on outside expertise to produce this data. The field of business strategy or management consulting is used to develop those strategies, and one such technique is U.S. Pat. No. 5,963,910 issued to Ulwick entitled “Computer Based Process for Strategy Evaluation and Optimization Based on Customer Desired Outcomes and Predictive Metrics.” The output of this technique, however, is limited to yielding a strategic option prioritized by satisfaction and importance from customers without reference to the price or dollars they are paying or willing to pay. Further, the output is a set of prioritized options rather than a demand rating upon which to compare suppliers and measure untapped potential.

In addition to data on internal operations and those of their top competitors, suppliers must also understand what customers want or need to develop a successful strategy. Suppliers deliver products and services that contain Attributes to meet customers' requirements. Three types of customers exist: prospective, current and defected. Prospective customers are those that have never purchased from the supplier before. Current customers are those that have recently purchased from the supplier. Defected customers are those that previously purchased from the supplier and have now purchased from another supplier.

To determine customer requirements, suppliers rely on surveys, interviews and other techniques to assemble how satisfied customers are with them and how loyal they intend to remain. Suppliers sometimes ask whether customers are willing to buy again, or willing to recommend them to someone else, to determine customer loyalty. Often, suppliers will ask the relative importance and satisfaction of each Attribute in a survey. The field of customer satisfaction and loyalty is dedicated to this task. While the satisfaction/importance approach provides excellent output on a supplier's ability to deliver and perform, no data exists on the customers' desires of each Attribute or future Attributes to consider. Further, the data is unable to be directly correlated to the price paid.

To go beyond existing offerings and discover new Attributes to offer, suppliers may conduct discussions or focus groups with prospective, current or defected customers. This provides suppliers with a more innovative way to approach customer requirements, yielding more non-traditional and “out-of-the-box” Attributes. The field of market research is typically used to accomplish this task, and one such technique is U.S. Pat. No. 6,315,569 issued to Zaltman entitled “Metaphor Elicitation Technique with Physiological Function Monitoring”. The output of this technique and other types of market research, however, stops at providing how a customer thinks or behaves with no integration of demand ratings, pricing or comparative data on multiple supplier's ability to deliver on an Attribute set.

A means for bringing together customers' desires and the ability for suppliers to deliver on those desires to predict customer behavior is disclosed in U.S. Pat. No. 6,658,931 to Williams et al., who is also the author of this invention. Williams' discloses a strategic profiler method in which participants enter ideals, reality and experiences to establish a set of value drivers where each driver is associated with a factor from a multi-factor personality model. The data are then analyzed to see how closely reality meets the ideal. As with other market research, the technique does not integrate pricing into those desires and provides no means for rating suppliers or segmenting customers with common desires and price points for those Attributes.

The fields of business strategy, customer research and market research rarely integrate the prices paid or willingness to pay more for a defined set of Attributes. Yet, to accurately assess demand and win more business, suppliers must establish a fair price in return for those Attributes (features, functions and benefits, etc.) being sold. With every product launch and upgrade, customers are demanding more to be delivered for equal or less money than what they previously paid. Virtually every industry—from Airlines and Automotive to Personal Computers and Wireless Phones—has been impacted by this shift in the U.S. economy. The “more for less” insistence from customers covers all price levels, from low- or discount-pricing to high- or premium-pricing. Suppliers must continually struggle to find profitable ways to incorporate more value into their offerings without an equal increase in expenses.

To set prices, suppliers typically use one of three methods, or a combination of them, which can be summarized by the following: 1) Determine the cost to manufacture or service an offering and then add a markup or percentage for profit and, 2) Track historical pricing and supply over time to optimize pricing (i.e. yield management), or 3) Discover the perceived value of the features and benefits to a customer, ultimately setting the price at what they “think” they can charge for their offering. Each of these methods offers an incomplete means for examining demand in respect to price.

The first method, cost-based pricing, is driven exclusively by the supplier's expenses and subjective need for profit, and ignores whether a customer is willing to pay the price in return for the delivery of those Attributes. For example, just because a supplier's costs to manufacture an automobile are $400,000 does not mean any customer will purchase an automobile for that amount. Likewise, an automobile that costs $400 to manufacture does not guarantee demand from customers.

The second method, historical-based pricing, is driven exclusively by the past without consideration for new developments, events or economic disturbances. In U.S. Pat. No. 5,712,985 (Lee et al.), the method for estimating business demand is based on multiple influence factors from storing past events and occurrences and projecting them into the future for estimating demand. The projected demand is created by selectively combining variables from the influence profile and actual demand is monitored for future inclusion to the profile. No measurements of how a customers' desires or perception of delivery occurs. For example, just because customers in the past purchased vinyl records does not mean they will continue to do so after compact discs with digital music appear.

The third method, benefits-based pricing, combines various levels of qualitative analysis such as focus groups and open-ended questioning with quantitative analysis such as conjoint analysis or perceptual mapping. The relationship between the perceived value of the benefits and what a customer would pay is fuzzy at best, given that there is no hard data but only soft data collected by qualitative questions. Often, pricing is left to the general intuition or gut-feel of the researcher. This method lacks the level of discipline, consistency or statistical accuracy required for such critical decision-making. There is no direct integration or relationship of the desires, delivery and dollars paid.

Consequently, the present invention overcomes the deficiencies, shortcomings and disadvantages by creating a 3-D customer demand rating method and apparatus based on customer desires, suppliers' ability to deliver on those desires, and the dollars (or prices) paid and willing to be paid for those desires.

### REFERENCES CITED

U.S. Patent Documents

| | | |
|---|---|---|
| 5,712,985 | January 1998 | Lee, et al. |
| 5,963,910 | October 1999 | Ulwick |
| 6,315,569 B1 | November 2001 | Zaltman |
| 6,658,931 B1 | December 2003 | Williams, et al. |

Other Publications
Dent, Harry S., Jr., “The Roaring 2000s”, Simon & Schuster, 1998, p. 45-50.
Frank, Robert J., George, Jeffrey P., and Narasimhan, Laxman, “When your competitor delivers more for less”, The McKinsey Quarterly, 2004 Number 1, p. 49-59.
Gladwell, Malcolm, “The Tipping Point”, Little, Brown & Company, 2000.
Grove, Andrew S., “Only the Paranoid Survive,” Currency Doubleday, 1996.
Marn, Michael V., Roegner, Eric V., Zawada, Craig C., “Pricing New Products”, The McKinsey Quarterly, 2003 Number 3, p. 40-49.
Peppers, Don and Rogers, Martha, “One-to-One Marketing”, Currency Doubleday, 1996.

### BRIEF SUMMARY OF THE INVENTION

The 3-D customer demand rating method and apparatus provides a way for suppliers to measure the level of demand for their offerings and make informed decisions about the Attributes they deliver, such as advertising, publicity, marketing, resources, production, distribution and service. The method and apparatus of the present invention is based on the establishment of common scales and metrics upon which to compare customers' desires, suppliers' abilities to deliver on those desires and the dollars or price paid for the delivery.

For purposes of this application, a “customer” is an individual that is actively considering a purchase of a supplier's offering, has purchased the offering in the past, or purchased the offering in the past and has discarded it and purchased another offering from a different supplier. A customer's desires are those needs, requirements, wishes, feelings, or emotions that a customer requests from a supplier, its offerings and its Attributes. An Attribute is any feature, function, benefit, service, person, location, action, program or event that can be delivered by a supplier in connection with an offering. A supplier's delivery for an offering is the complete set of Attributes that a supplier provides or dispenses in return for a given price. A dollars or price paid is the monetary value exchanged with a supplier in return for their offerings.

For example, a traveler wanting to fly an airline from one city to another pays for a ticket and expects to arrive at the stated destination according to the stated departure and arrival times. The traveler desires certain Attributes in exchange for the price paid, such as adherence to the time schedule, a seat, storage for baggage, safe arrival, etc. Certain attributes may or may not be included in the monies paid such as entertainment (movies, television, flight attendant banter, etc.), food and drinks. Some travelers are willing to pay more for these and other optional attributes while others will never pay for them. Discovering the right mix of attributes desired and delivery acceptable in return for a specific price with a group of travelers is critical to creating and maintaining demand for that airline.

In order to quantify demand, the present invention requires that a common set of metrics be established for measuring desires, delivery and dollars. While many tools exist for collecting such measurements, the most common tool for collecting this research is an interview. The interview can be performed face-to-face, in focus groups, on the telephone, mailed in paper form, faxed or online via the internet. The questionnaire for the interview can take a variety of shapes, technique or formats provided that the results can be converted into a numerical scale for comparative purposes.

After establishing a common set of metrics for the measurements, data collection takes place via the interview. The interview contains sets of questions about the Attributes and their desires for each one. The same sets of questions are repeated about a supplier's ability to deliver on those Attributes. The set of questions can be repeated for any number of suppliers, provided the customer has knowledge of each. The customer must also state what price they paid or are willing to pay for the delivery on those Attributes. Other related questions may be included in the interview to help identify trends or tendencies within demographic groups, media usage, lifestyle, preferences, behaviors, attitudes, emotions, product usage and other traditional market research fields.

Once collected, the Attribute set must be collapsed to its core drivers of demand that customers desire. These demand drivers, often numbering from 2 to 5, collectively represent and retain all the Attributes yet are more manageable for comparative purposes. A common statistical program can reduce the attributes to demand drivers through factor analysis. The raw responses from each Attribute can be averaged within a demand driver. These averages are now called pre-scores.

With the pre-scores for each demand driver, a norms table is created. These norms tables plot the measurements to properly illustrate their real differences, virtually always creating a curvilinear or S-curve pattern with any amount of substantial customer responses. The demand drivers and norms tables can be used for calculating pre-scores for desires and supplier delivery. A norms table is also created for the dollars paid. Using common scales in the norms tables for desires, delivery and dollars provides a means to compare and interpret them. The scores from the norms tables are called indexed scores.

Using the indexed scores for desires and dollars paid, groups of customers with similar levels of desire at particular price points can be identified. These groups—referred to as customer segments—may or may not be from different socio-economic backgrounds, live in different cultures or frequent different restaurants, but they desire the same set of Attributes and are willing to pay the same price for them. This similar view provides a way for suppliers to deliver and communicate to the segment in a common way.

Most suppliers operate off the theory that customers with high desires are willing to pay high prices, those with medium desires are willing to pay medium prices and those with low desires are willing to pay low prices. Typically, only a portion of the full customer set possesses this level of alignment, and often the desires-dollars differences from one segment to another are drastic. For example, a segment may be high in desires and low in dollars. These customers are not willing to pay much in exchange for what a supplier delivers, and would likely prove unprofitable to most.

The output of the 3-D customer demand rating method explains several anomalies often perplexing suppliers today. For example, why do loyal customers defect after long periods of time even though they remain satisfied? What happens is that new competitors appear on the landscape that drives desires up of those loyal customers, causing them to ultimately defect to another supplier while still reporting satisfaction with the previous' supplier. Some suppliers also continually post profits in traditionally commodity markets—such as airline, e-commerce or personal computer to name a few—whereas other suppliers are not. What happens is these suppliers find one or more customer segments where desires and dollars are aligned, or dollars are higher than desires, and their ability to deliver is better than competitors.

The 3-D customer demand rating method comprises the following steps:
Step 1. Attribute Definition. Define the Attributes to measure for a supplier, an offering, a product or service.
Step 2. Supplier Definition. Define the set of suppliers, offerings, products or services upon which to rate their delivery.
Step 3. Price Definition. Define the price points or question that cover the range of prices available from each supplier or offering that delivers all or a subset of the Attributes.
Step 4. Customer Definition. Define the fields to collect for identifying the demographic, media usage, behavior, attitudes, purchasing habits, product usage, socio-economic, etc. backgrounds of each customer.
Step 5. Interview Questionnaire. Build a set of questions to collect data about each of steps 1 through 4. The sections typically represent four distinct areas: Customer Background, Customer Desires, Supplier's Delivery and Prices Paid for Delivery.
Step 6. Conduct Interviews. Invite or seek out active customers to complete the interview.
Step 7. Demand Drivers. Reduce the Attribute set to a small number of demand drivers using factor analysis and calculate pre-scores for each driver.
Step 8. Norms Tables. Create norms tables based on the pre-scores for Customer Desires, Supplier Delivery, and Pricing and calculate the indexed score.
Step 9. Demand Segments. Cluster groups of customers by the indexed scores of desires for demand drivers and dollars paid.
Step 10. Demand Rating. Calculate the demand rating of each segment.
Step 11. Demand Profile. Build a profile of demand based on the desires, delivery and dollars based on demand drivers, demand segments, supplier, price points, attributes, demographics, socio-economics, media usage, etc. or any combination of the collected fields.
   The 3-D Demand Rating System and Apparatus

In order to achieve the steps for the 3-D Demand Rating method, an apparatus is provided whereby a researcher is able to collect the data from each customer interview and provide an analysis in the form of a 3-D Demand Profile. The apparatus comprises the required and preferred set of questions (Steps 1 through 4) into an interview questionnaire (Step 5).

The researcher can then conduct interviews (Step 6) via any acceptable means or forum such as in-person, focus group, mail, e-mail, fax or online/internet techniques. The researcher can then calculate the indexed scales appropriately (Step 7), discover the demand drivers (Step 8) and segments (Step 9) and examine the demand ratings (Step 10) overall or for each segment.

The final creation of the 3-D Demand Profile is the summation of all the 3-D Demand Ratings sliced by any of the collected data fields, including the three dimensions of desires, delivery and dollars themselves. The researcher uses these profiles for comparing ratings of competitive benchmarking in addition to traditional marketing research such as demographic groups, media usage and purchasing habits.

### BRIEF DESCRIPTION OF THE FIGURES

FIG. 1.—3-D Customer Demand Rating Method

FIG. 2.—Supplier Attributes

FIG. 3.—Customer Identifiers

FIG. 4.—Customer Desires for Supplier Attributes

FIG. 5.—Supplier Delivery for Attributes

FIG. 6.—Dollars Paid for Supplier Delivery

FIG. 7.—Demand Profiles and Analysis

FIG. 8.—Apparatus for Automated 3-D Customer Demand Ratings

### DETAILED DESCRIPTION OF THE PREFERRED EMBODIMENT

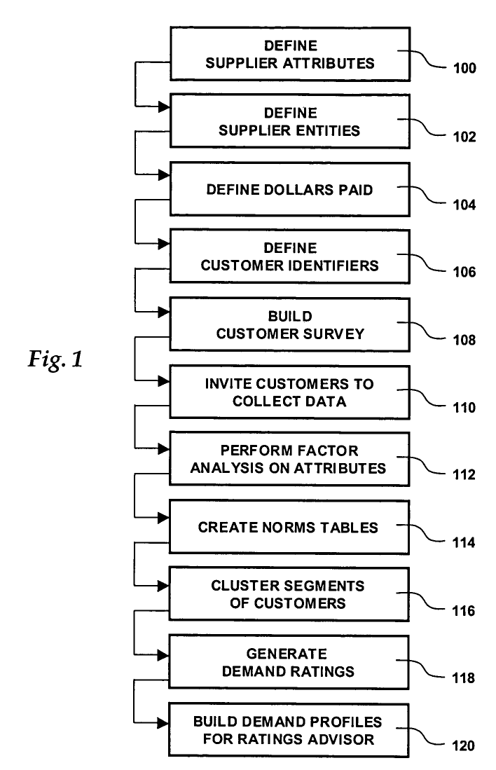

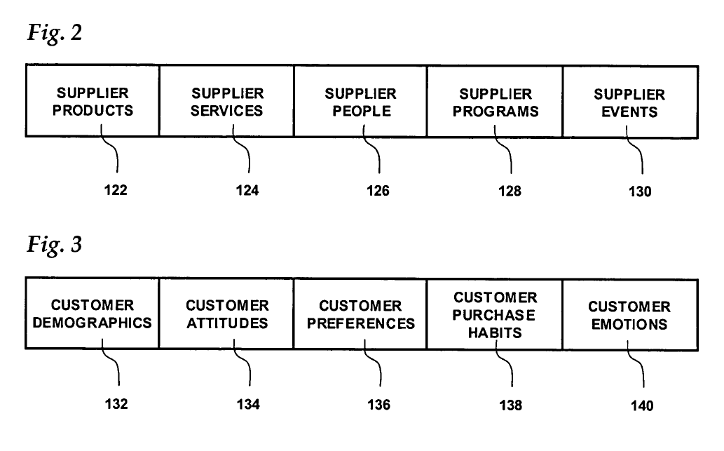

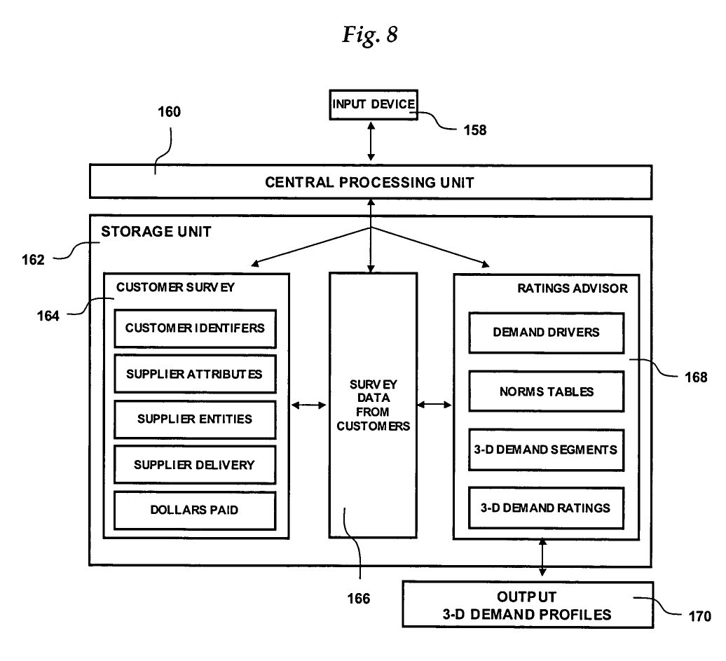

With reference to the drawings, FIG. 1 represents the 3-D customer demand rating method in its preferred embodiment and FIG. 2 through FIG. 7 represent how to use the method. FIG. 8 represents the apparatus for automated 3-D customer demand ratings.

In reference to numeral 100 in FIG. 1, Step 1 requires the researcher to define the supplier attributes to measure. These attributes often take the form of a specific product, service or offering but may also be a person, event, or program as shown in FIG. 2. Attributes can also be any combination of numerals 122 through 130 in FIG. 2. These Attributes may end up being described as an experience or even the entire supplier itself. For example, the researcher can measure the restaurant experience, the restaurant supplier or “chain of restaurants”, the restaurant brand, restaurant menu, or even the restaurant manager or bartenders. Similarly, the researcher can measure the airline experience, the airline supplier, the airline brand, the airline reservation system, or even the airline pilots or flight attendants. The key is for the researcher to decide on a fixed concept with defined Attributes to measure.

To define those Attributes, the researcher must examine all the promises being made when delivering the concept. Promises exist in three forms: 1) Explicit promises, 2) Implicit Promises, and 3) Future Promises. While the researcher should consider Attributes from all three types of promises, this invention does not require Attributes from each type. Explicit promises are those Attributes that the supplier is directly setting expectations for delivery. For example, an airline makes an explicit promise to depart and arrive at a particular time and destination. Similarly, a restaurant makes an explicit promise to deliver a particular combination of food choices in a menu. These Attributes are often the easiest to identify because they are often tangible and visible to a customer. They are often found in the basics or fundamentals of delivery.

Implicit promises are those Attributes that the supplier is indirectly setting expectations for delivery. For example, an airline makes an implicit promise to arrive at a destination without being tormented by other passengers or subjected to health hazards within the airplane. Restaurants make similar sets of implicit promises with their customers. The implicit promise is often an Attribute that is unlikely to be stated bluntly, yet is critical in terms of a successful delivery. In other words, restaurants are not likely to state, “All our servings are free from food poisoning.” Instead, they are more likely to state, “We have the best menu selections available.” To fully examine customer demand in a preferred embodiment, the researcher should include both explicit and implicit promises in the set of Attributes.

Future promises are those Attributes the supplier is considering for delivery in this concept but has never communicated before. Most suppliers perform some level of research and development in their industry and therefore possess delivery Attributes under consideration for future offerings. One of the strongest benefits of this invention is to be able to quantify the level of demand customers have today for those future Attributes to deliver before suppliers make investments in manufacturing or producing them. For example, a manufacturer for vinyl record stereos in the 1980's may have contemplated whether to make investments to increase the speed by which records can be played on a turntable or to improve the clarity of the sound. Both are future promises the manufacturer could make. Retrospectively, the demand for clarity was much higher than the demand for speed, which would have lead the manufacturer to abandon vinyl records and make investments in digital technology. Similarly, airlines may contemplate whether to make investments to enhance the service amenities of their flights with new options or to shorten the overall flight time between two cities.

The researcher may decide to not include any future promises into the Attribute set. In doing so, the customer demand ratings will only reflect the Attributes measured. By including future promises, suppliers often gain an advantage over competitors. The successful supplier is able to discover one or more Attributes of high demand that no other competitor has discovered yet. The source of these Attributes can be found in their own research and development labs, borrowed from another industry, or completely new.

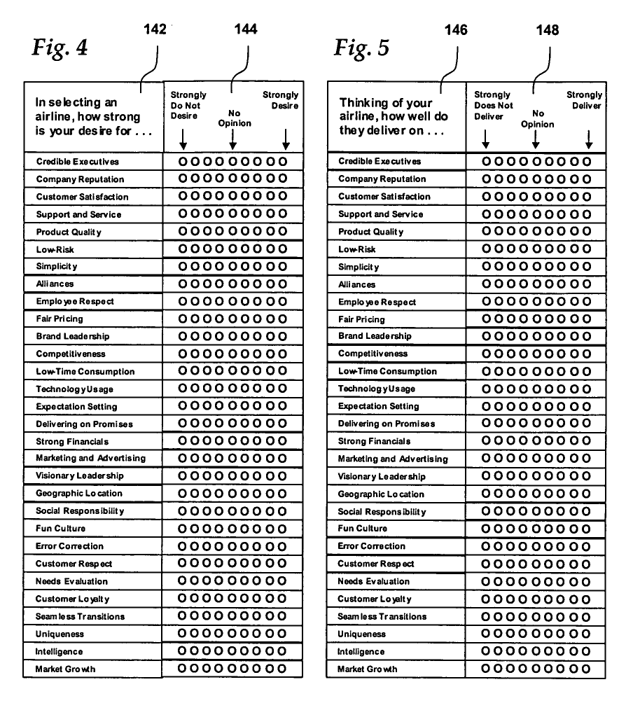

After assembling Attributes that represent explicit, implicit and future promises, the researcher must determine whether the concept to be measured is covered completely by those Attributes. This requires a mechanism with a 360-degree view of the concept and covers all key categories. For most concepts, the researcher accomplishes this by examining the delivery chain, which typically covers marketing, sales, distribution, implementation, service and disposal or transition. Each of the Attributes represented in numeral 142 of FIG. 4 could be mapped to one of these categories in the delivery chain. When the researcher is done mapping all Attributes, each category must contain at least one Attribute in order to be deemed complete.

Numeral 102 in FIG. 1 represents Step 2 of the invention to define the supplier entities able to deliver on the Attribute set. Most often these entities are a supplier or product, but could also be a person, event or program. For example, any airline could be included as an entity that delivers a set of Attributes for travelers. If the concept to deliver is broader than airlines and is defined as the traveler experience, the supplier entities includes not only airlines but also bus, train and automotive suppliers. Critical to the researcher is to have entities that are well defined by a single or small set of words familiar to customers. Customers must be able to rate how well the entity delivers on the Attribute set.

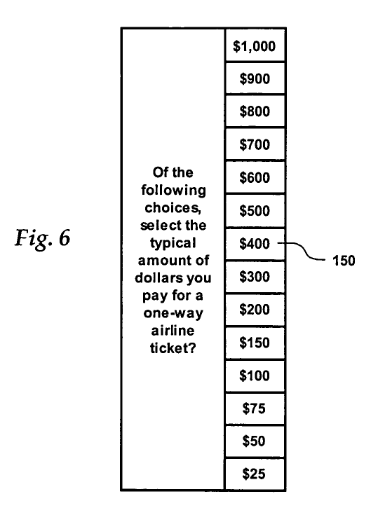

Step 3 of the invention, numeral 104 in FIG. 1., relates to collecting the dollars paid for the Attribute set being measured. The researcher must set up the price points or raw pricing for customers to enter the amount paid or willing to pay for the attributes. In FIG. 6., the numeral 150 identifies a series of price points ranging from $25 to $1000 for a one-way airline ticket in this example. Price points for other sets of Attributes may be quite different, and the researcher must investigate the supplier entities from Step 2 to create this list. Another option is to not ask a question with price points, but instead leave the question as a fill-in to the customer. The difficulty with this option is that some customers may enter the wrong number into the field, and the researcher would not know if the number was correct unless the customer entered the field with the researcher present. Because most survey data is entered independent from the researcher, this approach is not recommended. Most critical is that the researcher must include the lowest and highest prices reasonable for the Attributes with enough interval levels for a customer to reasonably select their price point.

In a preferred embodiment, the researcher would already know the answer to this question based on other unique identifiers—such as a loyalty card or membership ID in a user community—which the customer may enter in Step 4 of the invention. As represented in numeral 106 in FIG. 1, Step 4 defines the data fields to collect that best identify a customer. FIG. 3 illustrates many of these fields such as demographics (132), attitudes (134), preferences (136), purchase habits (138) and emotions (140). A loyalty card for a customer often tracks past purchases (138) for a customer thereby allowing the researcher to avoid asking the dollars paid question in Step 3. While this is preferred, most suppliers conduct research on non-customers thereby preventing this level of accessibility. Thus, this invention includes a step to collect this critical data.

One of the most powerful aspects of this invention is that the customer is not required to have made a purchase from a supplier entity in order to rate their performance. Prospective customers can project the performance of a supplier entity and rate their performance based on present knowledge. These are pre-purchase ratings that, when seen at very high levels, exemplify a pent-up demand. The pent-up demand is due to low or limited supply and high demand, which can be quantified using this invention.

In Step 5, the researcher must build the customer survey (Numeral 108 in FIG. 1) to collect all the data points required. The customer survey must contain the fields to collect on supplier Attributes (100), supplier entities (102), dollars paid (104) and customer identifiers (106) as illustrated in FIG. 1. The researcher presents the questions for supplier entities and customer identifiers according to their preferences, where dollars paid should be presented as previously discussed in Step 3 (Numeral 104). FIG. 4 and FIG. 5 represent the preferred way to present the supplier attributes to customers. In FIG. 4, the customer rates their desires for an airline along a likert scale where the mid-point represents no opinion and each end represents either strong desire or no desire at all. The mid-point helps to eliminate tendencies found in most purely numerical-scale ratings such as importance-satisfaction where all ratings end up at the high end of rating. In FIG. 5, the customer rates the performance of the supplier entity under measurement according to the same likert scale. In a preferred embodiment, the likert scale would be much larger than the nine intervals represented in FIG. 4 and FIG. 5. The scale would provide for much smaller measurements to occur down to at least the nearest hundredth, from 1.00 to 9.00.

In a preferred embodiment, the customer survey (numeral 164 in FIG. 8) is stored (numeral 162 in FIG. 8) in a computer where customers can complete the questions. Because not all customers have access to a computer, the survey can be offered in other non-digital formats such as paper or voice (via the phone or in-person).

In Step 6 (Numeral 110 in FIG. 1), the researcher must invite customers to the survey and collect data. In a preferred embodiment, this invitation is done with a pre-qualified set of customers that meet the criteria for a prospective or current customer. Further, the customer would complete the survey via an input device (Numeral 158 in FIG. 8) to store data through a central processing unit (Numeral 160 in FIG. 8). This data becomes a table within a database, illustrated by numeral 166 in FIG. 8.

The remaining steps of the invention, Numerals 112 through 120 in FIG. 1, refer to the ratings advisor and how the system calculates demand ratings based on customer survey data. The researcher must first load certain data into the ratings advisor, but afterwards the ratings advisor becomes an automated system that displays its output. In Step 7 (Numeral 112), the raw responses from the desires (FIG. 4) for a concept are converted into a matrix to determine which Attributes are similar to one another and thus can be explained by a single factor or construct. These factors are called demand drivers and in a preferred embodiment, no more than five appear from the analysis. Any basic statistical program can perform a factor analysis. Each Attribute now belongs to a demand driver, and ratings for those Attributes within a demand driver can be averaged to create a single demand driver pre-score. These pre-scores can then be used to build norms tables.

One alternative to performing a factor analysis is for the researcher to use the initial categories from Step 1. These categories were used to evaluate the completeness of the Attributes and therefore the researcher already possesses a means to summarize the Attributes into smaller groups. These would not be demand drivers but instead, demand categories. The difference is that demand drivers are statistically derived based on customer responses whereas demand categories are empirically derived based on the researcher's knowledge. In a preferred embodiment, this invention uses demand drivers.

In Step 8 (Numeral 114), the researcher creates several norms tables using the pre-scores from the survey data. Norms tables are derived scores that serve as a basis to greatly improve the comparison and interpretation of the pre-scores and raw response data. Several types of norms can be used, including but not limited to percentile ranks, standard scores and normalized standard scores. Norms tables from percentile ranks is the preferred embodiment for this invention. The percentile rank for a pre-score corresponds to the number of pre-scores falling below it. The researcher must first assemble all the pre-scores and the number of customer responses for each, known as frequency. To calculate any percentile rank from a pre-score, the researcher performs the following steps: 1) Sum the frequencies on all the pre-scores below the designated pre-score and call it SF for summed frequencies, 2) Add one-half of the frequency of the designated score to SF, and 3) Multiply the result by 100, and divide the product by the total number of pre-scores. These norms scores are called indexed scores, and they greatly improve the interpretation of data by highlighting the extremes of the scales. The further out the indexed score goes on the scale, the more significant a given numerical difference becomes. Thus, the difference between 50 and 55 is not as dramatic as the difference between 5 and 10 or 90 and 95. To ensure that no indexed score is zero for later usage in calculations, a kicker of 50 is added to each indexed score. This makes an indexed score of 100 the mid-point for the indexed scale.

The researcher must create norms tables for each demand driver from the raw responses for Attribute desires. These norms table can be used for both desires and performance because desires are what supplier entities are trying to deliver against. The researcher must also create a norms table for dollars paid. Creating identical scales for desires, delivery and dollars is what makes direct comparisons possible. The norms tables can be stored for easy lookup and retrieval in a computer (Numeral 168 in FIG. 8). When the same survey is repeated over time, norms tables can be created based upon hundreds of millions of customer responses versus a single point in time. In a preferred embodiment, these norms table would be set and updated on a regular periodic basis such as every six or twelve months.

In Step 9 (Numeral 116 in FIG. 1), the researcher performs a cluster analysis on the indexed scores for the desires of the demand drivers and the dollars paid. In a preferred embodiment, this would be no more than six columns of data (five columns of demand drivers and one column of dollars paid). Any basic statistical program can perform a cluster analysis. A cluster of customers is found where the individuals in that group are willing to pay the same price for a similar set of desires. In contrast to typical market segmentation, each customer in a cluster may or may not be similar in terms of demographics or socio-economics. But they are similar in terms of what they desire and are willing to pay for in return for those desires. These clusters are now called demand segments.

In Step 10 (Numeral 118 in FIG. 1), the researcher then calculates the demand rating for any individual customer or demand segment. A demand rating is calculated using the following steps: 1) Divide the indexed scores for Delivery by Desires, 2) Divide the indexed scores for Delivery by Dollars, and 3) Find the average of the two scores. The demand rating thus only goes up when one of the three changes occurs: Delivery increases, Desires decrease or Dollars decrease.

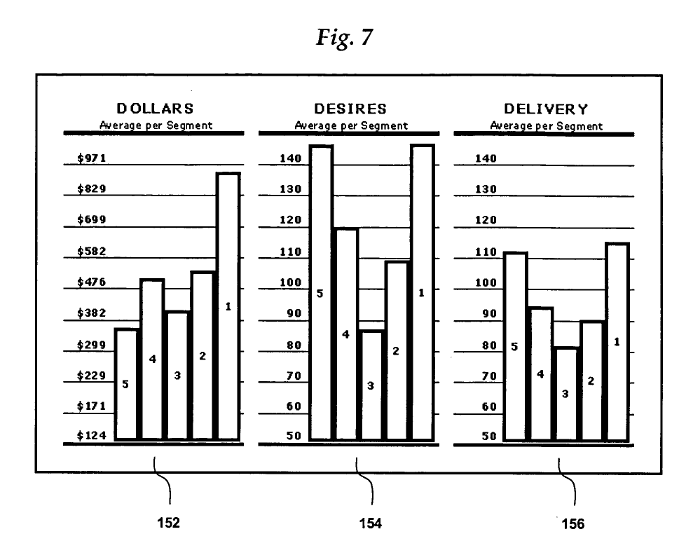

In Step 11 (Numeral 120 in FIG. 1), the ratings advisor creates the output for the customer demand rating method in the graphical format of a 3-D Demand Profile, illustrated in FIG. 7. This profile shows the dollars paid (Numeral 152), the desires (Numeral 154) and the average supplier delivery (Numeral 156). Each demand segment is identified by a numeric 1, 2, 3, 4 or 5. To interpret these profiles, the researcher examines whether a particular segment is paying too much (152) for what is being delivered (156). In the example here, every segment is paying more than what is being delivered except for Segment 5 where they are receiving more in delivery than what they are paying. The researcher then examines how aligned each segment's desires (154) are with the dollars being paid (152). In the example here, all segments have desires higher than what is being paid except for Segment 3. Further analysis shows that Segments 1 and 2 are close in aligning dollars-desires whereas Segments 4 and 5 still have far greater desires than dollars. Thus, Segment 5—while receiving the most delivery for their dollar—is still not receiving all their desires when compared to delivery. This segment is an example of a dissatisfied customer that continues to buy because they are still receiving more delivered than what they are paying, yet not completely what they desire. The researcher can now perform detailed analysis at the demand driver and Attribute level, comparing desires, supplier delivery and dollars paid.

FIG. 8 illustrates the apparatus for delivering the 3-D customer demand rating method in a preferred embodiment.

1. A method for rating customer demand based on customer desires, supplier's ability to deliver and the dollars paid for that delivery, the method comprising:
defining the supplier attributes to measure;
defining the supplier entities that are able to deliver the attribute sets being measured;
defining the dollars paid and price points for the supplier entity to deliver all or a subset of the attributes being measured;
defining the fields of customer identifiers;
building a set of questions into a customer survey to collect data;
inviting or selecting active customers to collect data by completing the interview;
reducing the attribute set to a manageable number of demand drivers that represent the attributes in terms of customer desires and supplier delivery with pre-scores for each driver;
creating three identically scaled norms tables from the pre-scores for customer desires, supplier delivery, and dollars paid that calculate an indexed score;
clustering groups of customers using the indexed scores of demand drivers and dollars paid;
generating the 3-D customer demand rating of each segment based on desires, delivery and dollars;
building and illustrating 3-D customer demand profiles based on desires, delivery and dollars.

2. The method of claim 1, wherein the Attributes to be measured describe a supplier, an industry, a product, a service, an offering, a program, an event, an emotion, a feeling, a person or any other inanimate or animate object.

3. The method claim 1, wherein the customer identifiers describe a person by demographics, attitudes, behaviors, emotions, purchasing habits, socio-economics and various other unique identifiers.

4. The method of claim 1, wherein the data collection of customer surveys occurs by best means possible according to the researcher, which may include paper, in-person or computer-based interviews.

5. An automated customer demand rating system comprising:
an input device that receives data from customer surveys;
a computer system including a central processing unit and a storage unit that responds to the survey data received by the central processing unit by rating the demand of each customer in terms of desires for supplier attributes, supplier ability to deliver on those attribute desires and the dollars paid or willing to pay for those supplier attributes.
an output device that graphically presents the data and 3-D demand profile.

6. The automated customer demand rating system of claim 5, wherein the computer system further includes:
a plurality of customer identifiers stored in the storage unit that identify the demographics, attitudes, behaviors, emotions, purchasing habits, socio-economics and various other unique ways to describe a customer; and
a plurality of supplier attributes stored in the storage unit from the raw responses of customer surveys in terms of their desires for an attribute and a supplier's ability to deliver on that attribute; and
a rating advisor in the storage unit that illustrates and clarifies which of the customer identifiers are more meaningful than others in relation to demand for that set of customers.

7. The automated customer demand rating system of claim 6, wherein the rating advisor:
generates segments of customers based on their common levels of desires and dollars paid or willing to be paid to a supplier to obtain those desires; and
generates detailed analysis within each customer segment by rating their level of desires for each supplier attribute; and
generates detailed analysis within each customer segment by rating the supplier's ability to meet desires for each supplier attribute; and
illustrates and clarifies within each customer segment which of the customer identifiers are more meaningful than others in terms of demand.

8. The automated customer demand rating system of claim 5, wherein the rating is calculated based on the indexed scores of customer desires for attributes, supplier delivery on those attributes, and the dollars paid or willing to pay for those attributes.

9. An apparatus comprising:
a storage unit;
a central processing unit configured to receive customer survey data; and
a customer demand rating system that responds to the survey data received by the central processing unit by rating the demand of each customer in terms of desires for supplier attributes, supplier ability to deliver on those attribute desires and the dollars paid or willing to pay for those supplier attributes.

10. The apparatus of claim 9, further comprising:
a plurality of customer identifiers stored in the storage unit that identify the demographics, attitudes, behaviors, emotions, purchasing habits, socio-economics and various other unique ways to describe a customer; and
a plurality of supplier attributes stored in the storage unit from the raw responses of customer surveys in terms of their desires for an attribute and a supplier's ability to deliver on that attribute; and
a rating advisor in the storage unit that illustrates and clarifies which of the customer identifiers are more meaningful than others in relation to demand for that set of customers.

11. The apparatus of claim 10, wherein the rating advisor:
generates segments of customers based on their common levels of desires and dollars paid or willing to be paid to a supplier to obtain those desires; and
generates detailed analysis within each customer segment by rating their level of desires for each supplier attribute; and
generates detailed analysis within each customer segment by rating the supplier's ability to meet desires for each supplier attribute; and
illustrates and clarifies within each customer segment which of the customer identifiers are more meaningful than others in terms of demand.

12. The apparatus of claim 9, wherein the rating is calculated based on the indexed scores of customer desires for attributes, supplier delivery on those attributes, and the dollars paid or willing to pay for those attributes.
